(19) United States
(12) Patent Application Publication
(10) Pub. No.: US 2002/0178934 A1
(43) Pub. Date: Dec. 5, 2002

(54) Dough spreader

(76) Inventor: Stanley E. Rodabaugh, Dixon, IL (US)

Correspondence Address: Richard C. Litman, LITMAN LAW OFFICES, LTD., P. O. Box 15035, Arlington, VA, 22215, US

(21) Appl. No.: 10/022,439

(22) Filed: Dec. 20, 2001

Related U.S. Application Data
(60) Provisional application No. 60/294,631, filed on Jun. 1, 2001.

(51) Int. Cl. A21C 11/00

(52) U.S. Cl. 99/646 R; 492/14; 425/458

(57) ABSTRACT

A device for kneading and/or spreading dough includes a base member having a semi-circular configuration. Shaped handles are disposed at each end of the base member. A user applies pressure alternatively to each handle to produce a rocking motion to knead and spread dough into a desired shape.

### CROSS-REFERENCE TO RELATED APPLICATION

This application claims the benefit of U.S. Provisional Patent Application Serial No. 60/294,631, filed Jun. 1, 2001.

### BACKGROUND OF THE INVENTION

1. Field of the Invention

The present invention generally relates to food preparation devices. More specifically, the present invention is drawn to a manual device utilized to knead and spread dough into a sheet.

2. Description of Related Art

In the modern, fast-paced world in which we live, the art of home baking has given way to pre-cooked and/or frozen breads, pies, pastries, etc. However, there is still a stalwart band of gourmet cooks and just plain homebodies who relish the idea of preparing tasty, baked goods from “scratch”. To accomplish this, an efficient device for spreading dough is required. In the past such a device has taken the form of a rolling pin, examples of which are shown in U.S. Patents numbered Des. No. 291,760 (Fallgatter et al.), No. 132,736 (Peirce), U.S. Pat. No. 3,831,238 (Adams), U.S. Pat. No. 4,045,850 (Brandes), U.S. Pat. No. 5,774,918 (Cassell et al.) and United Kingdom Patent number 2,105,967 A. All the rolling pins of the above cited patents require the traditional back-and-forth motion which is relatively tiring.

U.S. Pat. No. 4,070,742 (Dorfman) discloses a motorized rolling pin wherein the motor and controls are situated in the handle. The rolling pin of the instant patent is expensive and requires the availability of an electrical outlet.

U.S. Patents numbered Des. No. 346,724 (Ayala), Re. No. 30,221 (Moreno), U.S. Pat. No. 4,421,776 (Brinkers et al.) and U.S. Pat. No. 4,576,564 (Bernadi et al.) disclose mechanized devices for spreading dough, which devices are utilized in commercial establishments such as pizza parlors for processing large quantities of dough.

None of the above inventions and patents, taken either singly or in combination, is seen to disclose an uncomplicated, easy-touse dough spreader as will subsequently be described and claimed in the instant invention.

### SUMMARY OF THE INVENTION

The present invention is a unique device which employs an efficient and energy-saving rocking motion to spread dough into a sheet. The device is simplistic in construction and in its preferred embodiment comprises a one-piece, semi-circular base member of pre-determined radius of curvature, width and thickness. A handle is affixed at each end of the member on the inner circumference thereof. The handles may be unitary with the base member or attached thereto in some fashion.

The dough spreader of the instant invention can vary in size and may be fabricated from wood, plastic, marble, metallic material, etc. It is noted, however, that wood appears to be the more stylish material and lends a bit of “feng shui” to the kitchen which is attractive to people who enjoy cooking.

Accordingly, it is a principal object of the invention to provide a device for spreading and/or kneading dough into a sheet.

It is another object of the invention to provide a device for spreading dough, which device employs a rocking motion.

It is a further object of the invention to provide a device for spreading dough, which device is easy to use.

Still another object of the invention is to provide a device for spreading dough, which device is stylish and ergonomically friendly.

It is an object of the invention to provide improved elements and arrangements thereof in a device for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a dough spreader according to the present invention.

FIG. 2 is a perspective view of a dough spreader according to the present invention.

Similar reference characters denote corresponding features consistently throughout the attached drawings.

### DETAILED DESCRIPTION OF THE PREFERRED EMBODIMENT

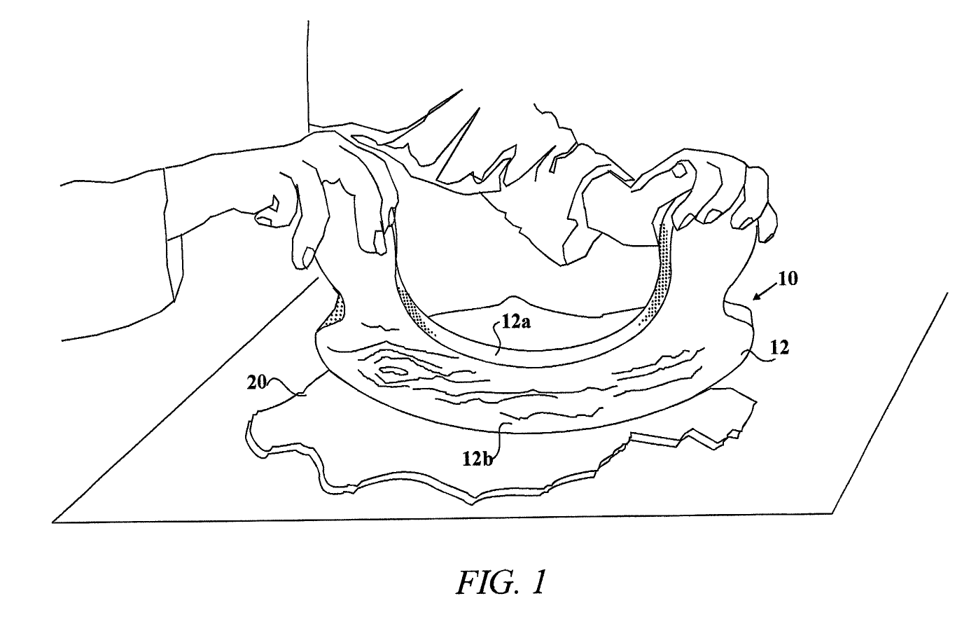

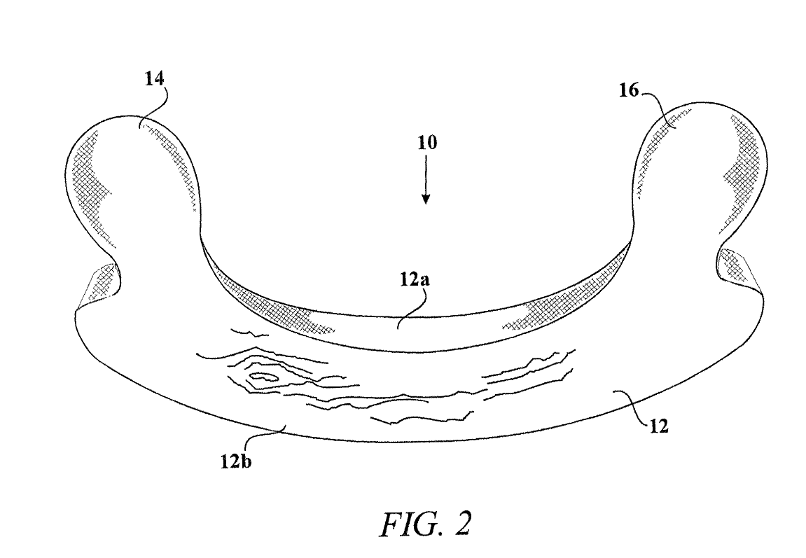

As illustrated in FIGS. 1 and 2, the present invention is generally indicated at 10 and comprises a base member 12. Base member 12 is configured as a semi-circle having respective inner and outer arched circumferential surfaces 12a and 12b. As noted above, base member 12 may be constructed to any suitable width, length and thickness. Handle members 14 and 16 are disposed at each end of member 12 along inner circumference 12a. Handle members 14, 16 are rounded at the top so as to afford comfortable grasping surfaces.

To employ the device of the instant invention requires a user to grasp the rounded handle portions 14, 16 as illustrated (FIG. 1) and alternately apply pressure to each handle to produce a rocking motion to knead and spread dough 20 which is disposed beneath and in contact with the surface of the device defined by outer circumference 12b.

It is to be understood that the present invention is not limited to the sole embodiment described above, but encompasses any and all embodiments within the scope of the following claims.

I claim:

1. A device for spreading dough comprising:
a base member, said base member configured as a semi-circle having an inner circumferential surface, an outer circumferential surface, a length, a width, a first end and a second end; and
means for rocking said base member back and forth to spread dough.

2. A device for spreading dough as recited in claim 1, wherein said means includes a first handle member, said first handle member disposed at said first end on said inner circumferential surface; and
a second handle member, said second handle member disposed at said second end on said inner circumferential surface.

3. A device for spreading dough as recited in claim 2, wherein said first handle member and said second handle member are of rounded configuration so as to present an ergonomic gripping surface.

4. A device for spreading dough as recited in claim 3, wherein said base member, said first handle member and said second handle member are of one-piece construction.

5. A device for spreading dough as recited in claim 4, wherein said base member, said first handle member and said second handle member are fabricated from wood.

6. A device for spreading dough as recited in claim 4, wherein said base member, said first handle member and said second handle member are fabricated from plastic.

7. A device for spreading dough as recited in claim 4, wherein said base member, said first handle member and said second handle member are fabricated from marble.

8. A device for spreading dough comprising:
a base member, said base member having configured as a semicircle having an inner circumferential surface, an outer circumferential surface, a length, a width, a first end and a second end;
a first handle member, said first handle member disposed at said first end on said inner circumferential surface; and
a second handle member, said second handle member disposed at said second end on said inner circumferential surface; and
wherein said base member, said first handle member and said second handle member are of one-piece construction.

9. A device for spreading dough as recited in claim 8, wherein said base member, said first handle member and said second handle member are fabricated from wood.

10. A device for spreading dough as recited in claim 8, wherein said base member, said first handle member and said second handle member are fabricated from marble.
